(19) United States
(12) Patent Application Publication
(10) Pub. No.: US 2005/0037177 A1
(43) Pub. Date: Feb. 17, 2005

(54) Non-migrating floor mat

(76) Inventors: Amy B. Streeton, LaGrange, GA (US); William O. Burke, LaGrange, GA (US)

Correspondence Address: Thomas L. Moses;Legal Department, M-495, PO Box 1926, Spartanburg, SC, 29304, US

(21) Appl. No.: 10/639,386

(22) Filed: Aug. 11, 2003

(51) Int. Cl. B32B 3/00

(52) U.S. Cl. 428/156

(57) ABSTRACT

A mat having a base layer that is bonded to a top layer. The base layer of the mat includes a plurality of depressions along the bottom surface of the base layer, wherein the depth of the depressions does not exceed the depth of the base layer. The orientation of the depressions on the bottom surface of the mat is such that there is a greater concentration of depressions along the edges of the mat. The top layer of the mat is preferably a layer of carpet tuft. In operation, the depressions of the mat suction the mat to the surface onto which the mat is placed once an initial force is applied to the mat, such as a footstep or vehicular traffic.

### BACKGROUND OF THE INVENTION

The present invention relates generally to slip resistant mats, and, more particularly, to mats having suction cups on the underside of the mats.

It is well known that rubber-backed floor mats tend to move along surfaces, such as wood, concrete, or tile, when walked upon. This movement can ultimately create tripping hazards. Further, additional labor and time must be spent to return the mats to their appropriate positions. Accordingly, various slip resistant or anti-skid features have been employed in the past to overcome these problems.

Historically, cleats have been added to the bottom surface of the mats so that the mats can better grip the surfaces onto which they are placed and thereby reduce their movement.

However, this approach did not prevent displacement of the mats on smooth floors, especially those floors with high traffic areas or loads being moved on them. This displacement results from the force of foot and vehicle traffic on the mats, which causes a deformation around the compressed area and then upon removal of such force the mats return to a different position.

Fasteners have also been employed with floor mats to reduce or eliminate the movement of the mats. For example, clips have been employed for securing the mats to a particular surface. Additionally, frames have been employed to secure mats onto a particular surface. Finally, tapes, adhesives, and hook and loop fasteners such as VELCRO® disposed along the bottom of the mats have also been used to secure the mats to the surfaces. However, these approaches add cost to the mats, as well as difficulty to the installation. Furthermore, such systems can damage the surface onto which a mat is secured.

Another traditional approach to reducing and eliminating the displacement of mats along a surface has been to include suction cups along the bottom surface of the mats. While this approach provides acceptable slip-resistance for applications involving lower traffic and lower load areas, such as bathrooms and showers, these suction cups do not provide sufficient anti-skidding forces to prevent slipping and movement in high traffic and high load areas such as grocery stores. Furthermore, traditional suction cups result in a wavy mat surface, which may be more difficult for individuals and loads to traverse. Finally, suction cups, which tend to have a thin edge, can break off from the mat when the mat is in use or cleaned.

Accordingly, there exists a need for an improved mat construction that eliminates migration of the mat along the surface on which it is placed

### SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. Its sole purpose is to present some concepts of the invention in a simplified form as a prelude to the more detailed description that is presented later.

According to its major aspects and briefly recited, the present invention is a mat having a base layer that is bonded to a top layer. The base layer of the mat includes a plurality of depressions along the bottom surface of the base layer, wherein the depth of the depressions does not exceed the depth of the base layer. The orientation of the depressions on the bottom surface of the mat may be such that there is a greater concentration of depressions along the edges of the mat. The top layer of the mat is preferably a layer of carpet tuft. In operation, the depressions of the mat suction the mat to the surface onto which the mat is placed once an initial force is applied to the mat, such as a footstep or vehicular traffic. Preferably, the base layer of the mat is formed from a soft, low durometer rubber compound by being plied to smooth mold so that the bottom surface of the mat is smooth.

A feature of the present invention is the use of a mat having a plurality of depressions along the bottom surface of the mat. These depressions effectively secure the mat to surfaces once an initial force is applied. Additionally, the depressions do not results in a wavy mat surface such as most mats including suction cups. Because the depressions do not have a thin edge such as most suction cups, but are instead molded into the bottom of the mat, the depressions are also able to better retain their shape and are more structurally sound thereby making the mat more durable.

Another feature of the present invention is the use of a mat having a plurality of depressions with a particular pattern. This pattern prevents the edges of the mat from curling up or wrinkling, because there is a greater concentration along the edges of the mat.

Still another feature of the present invention is the use of mat having a smooth bottom surface. The smooth surface results in a higher coefficient of friction and facilitates suction because the floor surface contact is increased. Accordingly, the movement of the mat along the surface is minimized.

Yet another feature of the present invention is the use of mat formed from a soft, low durometer rubber material. The softness of the rubber enhances the effectiveness of both the depressions and the smooth backing of the mat in securing the mat to a surface.

Other features and advantages of the present invention will be apparent to those skilled in the art from a careful reading of the Detailed Description of the Preferred Embodiments presented below and accompanied by the drawings.

### BRIEF DESCRIPTION OF THE DRAWINGS:

In the drawings,

FIG. 1 is a perspective view of the underside of a mat according a preferred embodiment of the present invention;

FIG. 2 is a cross-sectional view of the mat taken across Line 2-2 according to a preferred embodiment of the present invention;

FIG. 2A is a cross-sectional view of an alternate embodiment of the mat taken across Line 2-2;

FIG. 2B is a cross-sectional view of another alternate embodiment ofthe mat taken across Line 2-2;

FIG. 3 is a perspective view of a mat mold according to a preferred embodiment of the present invention.

### DETAILED DESCRIPTION OF THE PREFERRED EMBODIMENTS

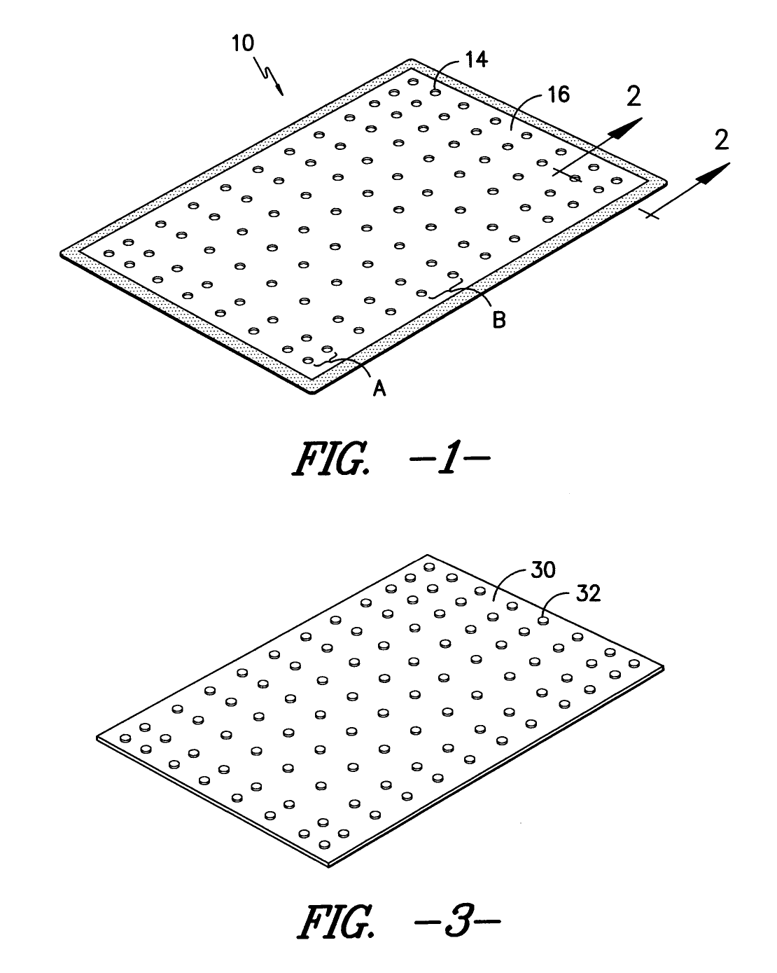

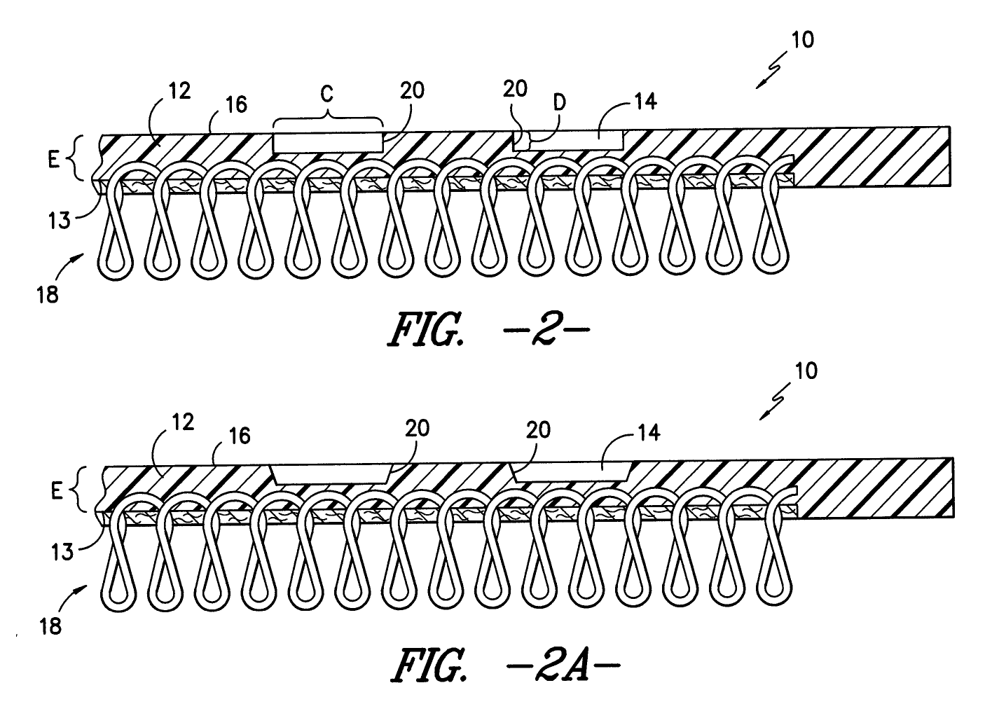

As illustrated in FIGS. 1 and 2, the present invention is a mat 10 having a base layer 12 with a top surface 13 and a bottom surface 16. The bottom surface 16 of the mat 10 includes a plurality of depressions 14. In a preferred embodiment, the top surface 13 of the base layer 12 is laminated or otherwise bonded to a top layer 18 of fabric, such as carpet tuft. It is contemplated by the present invention that any type of fabric can be employed in the top layer 18, including fabric made of nylon, polyester, and polyolefin fibers. Alternatively, the mat 10 does not include a top layer 18 of fabric at all. If the top layer 18 is included in the mat 10, the thickness of the top layer 18 is preferably between approximately 0.100 and 1.00 inches.

The base layer 12 is preferably made of rubber. However, other polymers may be used such as EPDM, which is sold by DuPont under the trademark NORDEL®, or SBR (styrene-butadiene) which is sold by Poly Corp. under the trademark POLYSAR®. More preferably, the base layer 12 is made of a rubber having a hardness between approximately 20 to 70 durometers, and, most preferably, between approximately 30 to 50 durometers.

As previously discussed, the use of a base layer 12 that is made of a soft, low durometer rubber material is a particular feature of the present invention. The softness of the rubber enhances the effectiveness of the depressions 14 the mat in securing the mat 10 to a surface.

Preferably, the depressions 14 are positioned in parallel and perpendicular rows resulting in a grid arrangement. Although a majority of the depressions 14 are evenly spaced along the bottom surface 16 of the mat 10, there is a greater concentration of depressions 14 along the edges of the mat. An effective range of depression 14 spacing is approximately 3 to 10 inches. Most preferably, the spacing between the two outermost rows of depressions 14 along the edges of the mat 10, shown as space A, is approximately 3 inches, whereas the spacing between the remaining rows of depressions 14, shown as space B, is approximately 6 inches. As previously discussed, this particular orientation is a feature of the present invention, because it helps to prevent the edges of the mat 10 from curling up or wrinkling thereby creating a tripping hazard. It should be understood that any suitable pattern, including random patterns, for the depressions may be used on the bottom of the mat.

Although the shape and size of the depressions 14 may vary depending on the particular end use of the mat 10, the depressions 14 are preferably shaped like a cylinder or a recessed circle having a diameter C and a depth D, which is less than the depth E of the base layer 12 of the mat 10. Most preferably, diameter C is approximately 1 inch, depth D is approximately 0.125 inches, and depth E is between approximately 0.140 and 0.250 inches. The depressions 14 in a most preferred embodiment are cylindrical in shape, where the sidewalls 20 of the depression are substantially perpendicular to the bottom planar surface 16 of the base layer 12, as shown in FIG. 2. It should be understood, however, that the depressions may also be formed into other shapes, such as square or diamond shaped, so long as the shape of the depression does not in any way break or disturb the smooth plane of the bottom surface of the mat. One particularly useful shape for the depression is a frustum shape. Embodiments employing the frustum shaped depressions are shown in FIGS. 2A and 2B. In FIG. 2A, the frustum shaped depression is oriented so that the base of the frustum is positioned adjacent the bottom surface of the mat. Conversely, FIG. 2B shows the frustum shaped depression being oriented so that the apex of the frustum is positioned adjacent the bottom surface of the mat.

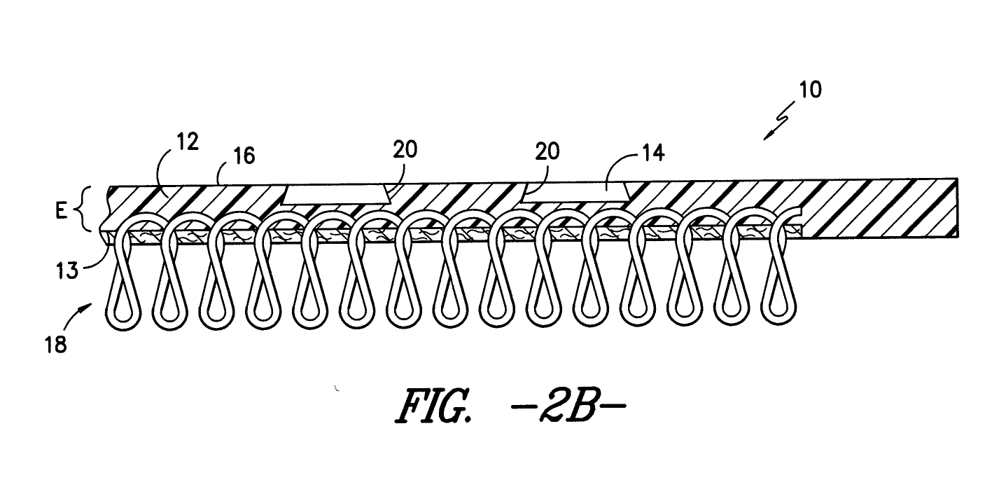

The base layer 12 of the mat 10 is formed by plying a material, such as rubber, to a mold 30, as shown in FIG. 3. Preferably, the mold 30 is a smooth plate having a plurality of projections 32, which are used to form the depressions 14. The plate may be made of such materials as steel, aluminum, ceramics or any other material that can be molded or machined into a pattern and have a smooth surface. The use of an aluminum plate is advantageous, because aluminum transfers heat readily and will heat up and cool down quickly. Aluminum is also preferred because it is lighter than other metal, and can be molded, machined and shaped more easily than other materials. The resulting base layer 12 is formed with a smooth or slick bottom surface 16. As discussed, having a smooth bottom surface 16 increases the coefficient of friction of the mat 10, and also facilitates the suction action against the floor surface. Therefore, movement of the mat 10 along the surface is decreased and minimized. Once the base layer 12 is formed, it is then laminated, or otherwise bonded, to the top layer 18 of fabric.

In operation, the mat 10 becomes suctioned to a floor surface after an initial force, such as a footstep or vehicular traffic, is applied. After such force is applied, the depressions 14 of the mat 10 are deformed and at least some of the air contained with the depressions 14 is forced out, which creates a low pressure area or near vacuum inside the depressions 14, thus creating a suction. In addition to the use of a smooth bottom surface 16, and a soft, low durometer rubber, the use of depressions 14 to suction the mat 10 to a surface further minimizes migration of the mat 10 along the surface. When used in combination, these features result in zero migration of the mat 10 along a surface to which it has been suctioned. As used herein, “zero migration” refers to a calculation in inches of mat displacement based on the Kex Walk Test. In a Kex Walk Test, markers, such as tape, are placed below the corners of the mat 10 to designate the original position of the mat 10. Subsequently, an individual will either walk over or push a grocery cart over the mat 10. Variations can exist as to what type of floor surface on which the mat 10 is placed. After a certain number of passes have been completed, the difference in inches between the original location of the mat 10 and the ending location of the mat 10 is measured.

### PREFERRED EMBODIMENT OF THE INVENTION

In order to further describe the present invention, the following nonlimiting example is set forth. The example is provided for the sole purpose of illustrating the preferred embodiment of the invention and is not to be construed as limiting the scope of the invention in any manner.

### EXAMPLE 1

A first mat having a mat size of 3 feet by 10 feet, weighing approximately 21 lbs., and having the features described above, including a base layer made of rubber that is bonded to a top layer of fabric, a smooth bottom surface, and a plurality of depressions having diameter of approximately 1 inch and a depth of approximately 0.125 inches, was subjected to the Kex Walk Test as described above. The mat was first washed with a non-ionic detergent at 140° F. Thereafter, the mat was placed on a hard tile floor surface over tape markers. Next, a walker pushing a grocery cart that was loaded to give the cart a total weight of 100 lbs. passed over the mat 50 times.

Comparatively, a second mat having a mat size of 3 feet by 10 feet and weighing approximately 12 lbs. was also subjected to the same Kex Walk Test. The second mat also included a base layer of rubber bonded to a top layer of fabric. However, the second mat did not include a smooth bottom surface and a plurality of depressions. In particular, the second mat was cleated on the bottom surface of the mat. This mat was also washed with a non-ionic detergent at 140° F. Thereafter, the mat was placed on a hard tile floor surface over tape markers. Next, a walker pushing a grocery cart that was loaded to give the cart a total weight of 100 lbs. passed over the mat 50 times.

After the passes by the walker and the grocery cart were completed, the migration of the first and second mats were measured by comparing the differences between the locations of the mats before and after the passes. The results follow.

| Mat identifica- | Movement in Inches on Left | Movement in Inches on |
|---|---|---|
| tion | Side of Mat | Right Side of Mat |
| First Mat | 0.00 | 0.00 |
| Second Mat | 1.94 | 1.75 |

Accordingly, this examples demonstrates the effectiveness of the skid resistant features of the mat 10 of the present invention over other mats known in the art.

Finally, there are many alternative embodiments and modifications of the present invention that are intended to be included within the spirit and scope of the following claims.

1. A mat, comprising:
a base layer having a top surface, a bottom surface and a depth E, wherein said bottom surface includes a plurality of depressions, at least one depression of said plurality of depressions having a depth D, and wherein said depth D is less than said depth E of said base layer, said plurality of depressions providing a suction force when at least a portion of air is expressed from within said plurality of depressions and said mat is engaging a surface.

2. The mat as recited in claim 1, further comprising a top layer that is bonded to said top surface of said base layer.

3. The mat as recited in claim 2, wherein said top layer is made of a fabric.

4. The mat as recited in claim 2, wherein said top layer has a thickness between approximately 0.100 and 1.00 inches.

5. The mat as recited in claim 1, wherein said base layer is made of rubber.

6. The mat as recited in claim 5, wherein said rubber has a hardness of approximately 20 to 70 durometers.

7. The mat as recited in claim 1, wherein said base layer is made of a material selected from the group consisting of EPDM and SBR.

8. The mat as recited in claim 1, wherein said bottom surface is smooth.

9. The mat as recited in claim 1, wherein said depth E is between approximately 0.140 and 0.250 inches.

10. The mat as recited in claim 1, wherein said depth D is approximately 0.125 inches.

11. The mat as recited in claim 1, wherein each depression of said plurality of depressions are cylindrical and have a diameter of approximately 1 inch.

12. The mat as recited in claim 1, wherein each depression of said plurality of depressions is positioned in rows.

13. The mat as recited in claim 12, wherein said plurality of depressions have a space A between the two outermost rows of said rows and a space B between the remaining rows of said rows.

14. The mat as recited in claim 13, wherein said space A is approximately 3 inches.

15. The mat as recited in claim 13, wherein said space B is approximately 6 inches.

16. A mat comprising:
a base layer having a top surface and a bottom surface, wherein said bottom surface is a smooth planar surface including at least one depression;
said depression providing a suction force when at least a portion of air is expressed from within said depression and said mat is engaging a surface.

17. The mat set forth in claim 16, wherein said depression further includes side walls extending in substantially perpendicular relationship to said snooth planar bottom surface.

18. The mat set forth in claim 16, wherein said depression is generally cylindrically shaped.

19. The mat set forth in claim 16, wherein said bottom surface of said base layer includes a plurality of said depressions.

20. The mat set forth in claim 19, wherein said depressions form a pattern.

21. The mat set forth in claim 16, further including a top layer that is bonded to said top surface of said base layer.

22. The mat set forth in claim 21, wherein said top layer has a thickness between approximately 0.100 and 1.00 inches.

23. The mat set forth in claim 16, wherein said base layer is made of rubber.

24. The mat set forth in claim 23, wherein said rubber has a hardness of approximately 20 to 70 durometers.

25. The mat set forth in claim 16, wherein said base layer is made of a material selected from the group consisting of EPDM and SBR.

26. The mat set forth in claim 16, wherein said base layer includes a depth E between approximately 0.140 and 0.250 inches.

27. The mat set forth in claim 16, wherein said depression includes depth D of approximately 0.125 inches.

28. The mat set forth in claim 19, wherein each depression of said plurality of depressions is cylindrical and has a diameter C of approximately 1 inch.

29. The mat set forth in claim 19, wherein each depression of said plurality of depressions is positioned in rows.

30. The mat set forth in claim 29, wherein said plurality of depressions have a space A between the two outermost rows of said rows and a space B between the remaining rows of said rows.

31. The mat set forth in claim 30, wherein said space A is approximately 3 inches.

32. The mat set forth in claim 30, wherein said space B is approximately 6 inches.

33. The mat set forth in claim 16, wherein said depression is frustum shaped.

34. The mat set forth in claim 33, wherein said frustum shaped depression is oriented so that a base of said frustum is adjacent said bottom surface of said mat.

35. The mat set forth in claim 33, wherein said frustum shaped depression is oriented so that an apex of said frustum is adjacent said bottom surface of said mat.
